(19) United States
(12) Patent Application Publication
(10) Pub. No.: US 2011/0219649 A1
(43) Pub. Date: Sep. 15, 2011

(54) Automobile hazard warning sign

(76) Inventor: Eric Spann, Charlotte, NC (US)

(21) Appl. No.: 12/661,030

(22) Filed: Mar. 10, 2010

(51) Int. Cl. G09F 21/04

(52) U.S. Cl. 40/550

(57) ABSTRACT

This invention will provide an alternative solution by providing a sign that connects to the car window which can display colors during the day or an electronic programmable sign at night. The back of the display will have an insert where owner contact information can be kept if the automobile has to be abandoned due to the vehicle being inoperative. The sign will provide automobile owners, highways drivers and law enforcement with the ability to identify an inoperative vehicle, help the owner of the car, prevent accidents on the highways, understand vehicle problem and help law enforcement contact the owner. To date there is no instrument or equipment to address the safety of driver with inoperative motor vehicles.

### BACKGROUND OF THE INVENTION

1. Field of the Invention

The present invention relates to a hazard sign for automobiles that can be connected to a car window (passenger or driver side) and display a color indicating a vehicle is stranded during the day and an electronic LED word display at night. The back of the display will also have an insert where owner contact information can be kept if the automobile has to be abandoned due to the vehicle being inoperative.

2. Background Information

This invention is a device for serving for safety and to help for citizens on highways. In particular, there are thousands of vehicles that become inoperative on highways. Usually citizens place a white cloth on the outside of the window, use hazard lights which drain the car battery, or abandon the automobile which is a danger to everyone on the highway with no easy way to contact the owner.

### DESCRIPTION

### Technical Field

The hazard automobile sign is intended to connect to car windows and display for color messages during the day and electronic text and/or numerical display at night for inoperative automobiles. The display will have easy slide tabs for day use which will display colors and text. Behind the color tabs will be an electronic LED sign that can display text/numbers at night.

### DESCRIPTION OF THE DRAWING

The hazard automobile sign is intended to be readable at large distances, especially on highways with little to no light.

FIG. 1 is a plan view of a first embodiment of the invention

FIG. 2 is a front plan view of the embodiment of invention with tabs with color message displays

FIG. 3 is a front plan view of the embodiment of invention with electronic text

FIG. 4 is a side plan view of the embodiment of invention with the hook which connects to the a car window

FIG. 4 is also the bottom plan view of the embodiment of invention with magnet display

FIG. 5 is a back plan view of the embodiment of invention with owner information insert display

### REFERENCES CITED

### Referenced By

### U.S. Patent Documents

| | | |
|---|---|---|
| 3,811,071 | May 1974 | Ogle |
| 4,006,476 | February 1977 | Rommey |
| 4,384,279 | May 1983 | Fujita |
| 4,445,132 | April 1984 | Ichikawa |
| | | et al. |
| 4,581,612 | April 1986 | Jones |
| 4,745,404 | May 1988 | Kallenberg |
| 4,771,278 | September 1988 | Pooley |
| 4,825,201 | April 1989 | Watanabe |
| | | et al. |
| 4,833,542 | May 1989 | Hara et al. |
| 4,897,651 | January 1990 | DeMonte |
| 4,901,155 | February 1990 | Hara et al. |
| 5,079,636 | January 1992 | Brody |
| 5,136,695 | August 1992 | Vest |

### Foreign Patent Documents

| | | |
|---|---|---|
| 0242742 | October 1987 | EP |
| 0247377 | December 1987 | EP |
| 3513607 | October 1986 | EP |

What is claimed is:

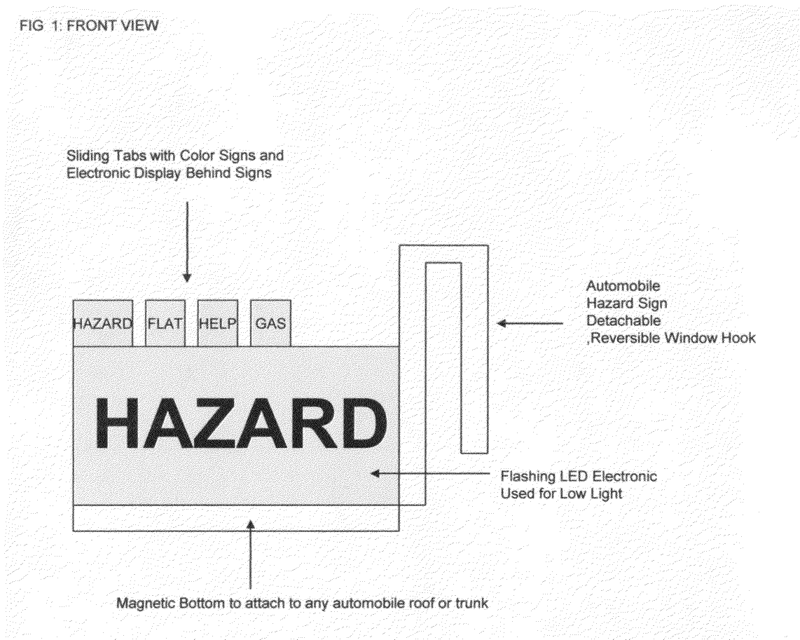

1. The hazard automobile sign is intended to connect to a car window and display for color messages during the day and LED electronic text and/or numerical display at night for inoperative automobiles. The display will have easy slide tabs for day use which will display colors and text. Behind the color tabs will be an electronic LED sign that can display text/numbers at night. (See FIG. 1)

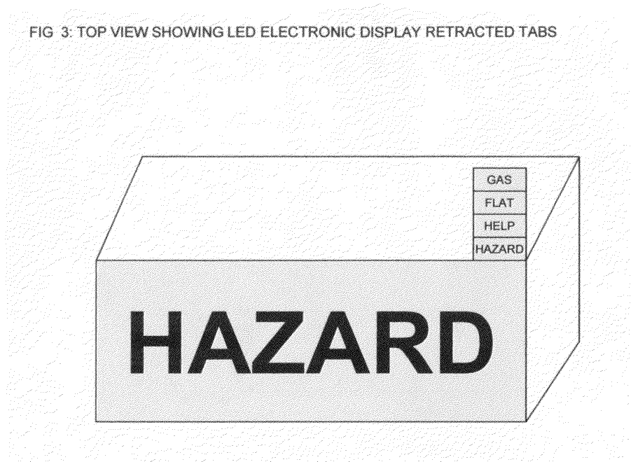

2. The hazard automobile sign as claimed in claim 1, will displays electronic programmed messages at night such as “HELP”, “HAZARD”, “FLAT”, “GAS” and others. (See FIG. 3)

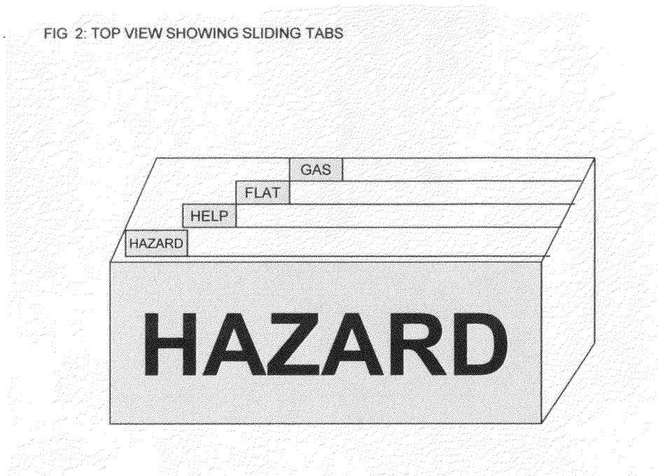

3. The hazard automobile sign as claimed in claim 1, will display colored signs during the day such as “BLACK”, “RED”, “GREEN”, “BLUE”, with white letters to mirror electronic messages. (See FIG. 2)

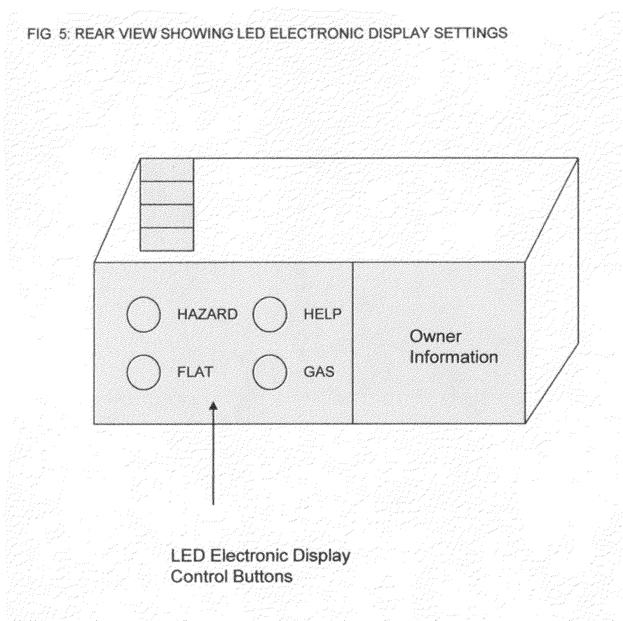

4. The hazard automobile sign as claimed in claim 1, the back of the display will have an insert where owner contact information can be kept if the automobile has to be abandoned due to the vehicle being inoperative. (See FIG. 5)

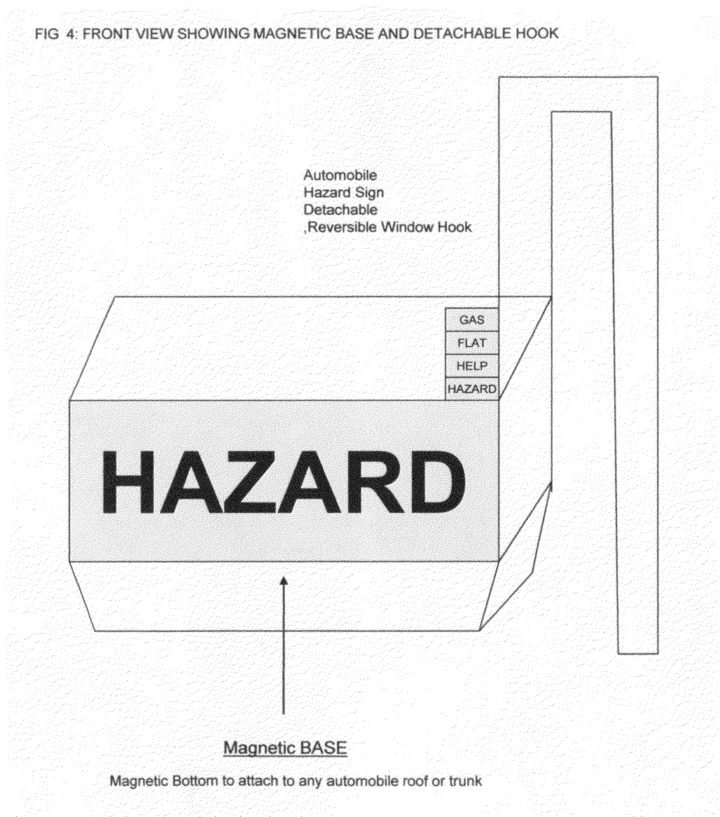

5. The hazard automobile sign as claimed in claim 1 can be connected to any automobile with the easy use hook that holds the sign from any closed window in the automobile if the owner abandons the vehicle. The sign will also be equipped with and magnet bottom to place the sign on the automobile while the driver is waiting on help. (See FIG. 4)
